(19) United States
(12) Patent Application Publication
(10) Pub. No.: US 2007/0046131 A1
(43) Pub. Date: Mar. 1, 2007

(54) Boat drive

(75) Inventors: Friedrich Boebel, Eurasburg (DE); Klaus Kraft, Blaustein (DE); Heinrich Walk, Allmendingen (DE)

Correspondence Address: CROWELL & MORING LLP;INTELLECTUAL PROPERTY GROUP, P.O. BOX 14300, WASHINGTON, DC, 20044-4300, US

(73) Assignee: Torqeedo GmbH, Starnberg (DE)

(21) Appl. No.: 11/511,316

(22) Filed: Aug. 29, 2006

(30) Foreign Application Priority Data
Aug. 30, 2005 (EP) 05 018 832.5

(51) Int. Cl. B63H 21/17; H02K 21/12; H02K 19/00

(52) U.S. Cl. 310/216; 310/156.45; 310/162; 310/156.37; 440/6

(57) ABSTRACT

A boat drive has a permanent magnet-excited, electronically commutated synchronous motor with a stator and a rotor. The number of poles of the stator and the number of poles of the rotor are different. The magnetic field created between the poles of the stator and the poles of the rotor is an essentially radial field with respect to the shaft of the rotor. The poles of the rotor have a greater distance from the shaft of said rotor than the poles of the stator.

This application claims the priority of EP 05 018 832.5, filed Aug. 30, 2005, the disclosure of which is expressly incorporated by reference herein.

### BACKGROUND AND SUMMARY OF THE INVENTION

The present invention relates to a boat drive comprising a permanent magnet-excited, electronically commutated, synchronous motor with a stator and a rotor, with the number of poles of said stator and the number of poles of said rotor being different.

Due to stronger environmental regulations, boats with electrical propulsion are more frequently used on lakes and also near the coast. Compared to combustion engines, electric motors have the advantage of being more silent and not water polluting, the later being in particular what occurs when using two-stroke engines.

The electric energy to operate such electric motors is supplied by batteries. However, batteries are relatively large and heavy so that only a limited number of batteries can be stored on board of the boat. Hence, the maximum range of an electrically driven boat is limited by the capacity of the batteries.

Therefore, for electrical driven boats there is a need to use a drive with an efficiency as high as possible in order to best utilize the limited capacity of the batteries. Normally, the boat drive comprises at least a motor, a propeller rotating within the water and means for transmitting the motor power to the propeller.

The overall efficiency of a boat drive is given as the product of the partial efficiency levels of all components, especially of the motor, of the power transmission, and of the propeller. The efficiency of the propeller essentially depends on its size. From an energy point of view, it is preferable to utilize a propeller which slowly turns in the water and which has a large diameter. The electric boat motor should therefore deliver a high torque at a relative low number of revolutions.

Further, the thrust of a propeller motor increases proportional to the square of the propeller diameter. In order to displace a heavy boat by a propeller drive, large propeller diameters are necessary.

U.S. Pat. No. 5,816,870 discloses an over-sized electric motor which is operated at about 30% to 40% of the full motor rating. Thereby, a high torque can be achieved in order to turn large propellers slowly. However, a disadvantage of such a boat drive is its weight due to the use of an oversized motor.

U.S. Pat. No. 6,664,692 B1 discloses an electric motor comprising a stator and a rotor with a different number of poles. But the differing number of poles causes an electrical reduction of the revolution speed. The motor is thus, in particular, useful for applications demanding slow rotation. The electric motor disclosed in U.S. Pat. No. 6,664,692 B1 is a disk armature motor with the axis of the magnetic field being parallel to the rotor rotation axis. That configuration allows geometries to be realized where the place of generation of electromagnetic power is relatively distant from the rotation axis, whereby larger torques can be achieved. But disk armature motors have the disadvantage of needing a large diameter which disqualifies them for being placed into the pylon of an outboard motor.

An object of the present invention is to provide an electric boat drive which has a high overall efficiency and low weight. In particular, an electric boat drive for an outboard motor is provided which can be placed into the pylon of an outboard motor and the like.

This object is achieved by a boat drive comprising a permanent magnet-excited, electronically commutated, synchronous motor with a stator and a rotor, the number of poles of said stator and the number of poles of said rotor being different. The magnetic field created between the poles of the stator and the poles of the rotor is an essentially radial field with respect to the shaft of the rotor and that the poles of the rotor have a greater distance from the shaft of the rotor than the poles of the stator.

According to the present invention, a synchronous motor without brushes or sliding contact means is used. The electric power is supplied by a battery or an accumulator. An electronic circuit, a so-called frequency converter, converts the DC current of the battery into a three-phase or multi-phase alternating current.

Stator and rotor of the present invention motor have a different number of magnetic poles. The different number of poles causes an electric reduction of revolution. That means, contrary to normal synchronous motors which have a rotor rotating with the same number of revolutions as the magnetic field generated in the stator, the motor of the present invention rotates more slowly.

According to the invention, the electric motor is configured as an external rotor motor. The stator is arranged in the center of the motor and the rotor rotates around the stator. Thus, the rotor poles, which are permanent magnets, have a greater distance from the rotation axis than the stator poles. The rotor can be configured as a ring or as a bell, i.e., the rotating magnets are located on an externally running ring or bell. The rotor shaft is identical with the stator symmetry axis.

The magnetic field generated between the stator poles and the rotor poles is directed radial to the rotor rotation axis. The electro-magnetic force is generated in the air gap between the inner stator poles and the rotor poles located on the surrounding rotor ring or rotor bell. Since these air gaps have a relative large distance from the rotation axis or rotor shaft, the inventive boat drive delivers a high torque.

With the same structural shape, external rotor motors have a significantly higher torque than internal rotor motors which have its rotor arranged in the center surrounded by the stator.

With external rotor motors of conventional design, there is the risk that the rotor and the permanent magnets fixed to the rotor cannot withstand the centrifugal forces. This is not true for the motor of the present invention because the centrifugal forces are essentially reduced due to the electric reduction.

The present invention provides a boat drive which is best adapted to the requirements of outboard boat drives. Such boat drives should deliver a high torque at a low number of revolutions. The low number of revolutions is achieved by the inventive configuration of a stator and a rotor having different numbers of poles which causes an electric reduction of the number of revolutions. By constructing the inventive motor as an external rotor motor, the air gap between the stator poles and the rotor poles has a large distance from the axis of rotation, thereby resulting in a high torque. The motor can be placed into the pylon or under-water housing of an outboard drive. Thereby, no additional transmission apparatus is necessary to transmit the motor power to the propeller. In addition, the motor located within the pylon is cooled by the surrounding water.

According to a preferred embodiment, the stator of the synchronous motor comprises an even number of stator cores wherein only every second core is provided with a winding. A three-phase current or a multi-phase current flows through the windings generating a rotating magnetic field. Preferably, a different phase is applied to adjacent windings.

The term “stator cores” shall mean all kinds of noses, grooves, or recesses which conduct magnetic flux and which can be used to fix windings which conduct electricity. The stator cores are essentially arranged on a circle.

The inventive synchronous motor is permanent magnet-excited, that is the rotor comprises several permanent magnets which are regularly arranged on its circumference. The magnetic field rotating in the stator affects the magnetic poles of the rotor and causes the rotor to turn.

In the stator, a magnetic flux is generated which extends from a first stator core having a winding along a part of the rotor to the neighboring stator core and along the stator back to the first stator core with winding. Thereby, each stator core acts as a magnetic pole, the stator cores having a winding as well as the stator cores without winding.

According to the invention, the stator and the rotor have a different number of magnetic poles. That means that the number of stator cores is different from the number of permanent magnets fixed to the rotor. Thereby, the number of revolutions of the synchronous motor is electrically reduced.

Preferably, the number of rotor pole pairs and the number of stator pole pairs differ by ±1, that is either the number of rotor pole pairs exceeds the number of stator pole pairs by one or vice versa.

The number of rotor pole pairs can easily be calculated by dividing the number of permanent magnets fixed to the rotor by two. When determining the number of stator pole pairs in the above mentioned embodiment, the stator cores with windings as well as the stator cores without windings have to be taken into account. The magnetic flux also extends to the stator cores without windings. Thus, all stator cores are magnetic poles. The number of stator pole pairs is hence half the number of stator cores.

Preferably, the rotor has between 4 and 8, more preferred between 5 and 7, pairs of poles. According to a preferred embodiment, the stator has 12 stator cores wherein 6 of them comprise windings. The number of stator pole pairs is thus also 6. It can be shown that using 6 stator pole pairs and 5 rotor pole pairs relates to a 1:5 down-geared transmission, that is the number of revolutions is reduced by a factor 5.

An even more preferred reduction of 1:7 can be achieved if the rotor is designed with 7 pole pairs respectively 14 permanent magnets and the stator with 6 pole pairs. In that case, the rotor rotates 7 times slower than the magnetic field generated in the stator.

The high number of poles between 4 and 8, preferably between 5 and 7, causes a high degree of overlap of the magnetic poles of rotor and stator independent of the angular position of the rotor. The distance between the magnetic poles of the rotor and the magnetic poles of the stator is relative low so that the magnetic force is relative high resulting in a high torque.

The inventive boat drive provides a high torque at low number of revolutions—due to the electric reduction—and thus exactly fulfils the requirements of an electric boat drive. The motor can turn large-diameter propellers at low speed. Thereby, a high overall efficiency can be achieved, that is the relationship between the output power which is actually used to move the boat and the input power is high. At a given battery capacity, the maximum range of the boat can be significantly increased compared to a boat equipped with a conventional electric boat drive. In addition, the inventive drive provides a high thrust so that it is possible to displace large and heavy boats even by small and light-weight motors.

The electrical reduction has the further advantage that the frictional forces in the rotor bearings are essentially reduced since the frictional forces are proportional to the number of revolutions. Therefore, conventional bearings can be used in the inventive boat drive. It is not necessary to use special bearings, such as ceramic bearings.

In a preferred embodiment, the inventive boat drive has no additional mechanical transmission or gearing mechanism. That is, the number of revolutions of the inventive motor is only reduced by the above mentioned electric reduction. Thus, additional weight is saved and the sometimes whining sound of the gearing mechanism is avoided. However, it is of course also contemplated to use a separate mechanical transmission together with the inventive boat drive if necessary.

Preferably a sensorless controller is used. That is no special sensor is needed to determine the actual position of the rotor poles relative to the stator poles.

The inventive motor is preferably capable of an output power measured at the drive shaft between 100 W and 10 kW, more preferred between 100 W and 5000 W, most preferred between 500 W and 4000 W.

The inventive motor is preferably supplied with an electric voltage between 12 V and 60 V. The electric currents can be as high as 100 A depending on the power of the motor.

The high power-weight ratio and the high torque of the inventive motor make it possible to produce compact and lightweight motors.

An outboard motor or outboard boat drive comprises a motor, a propeller, a drive shaft or any other power transmission means, and a shaft connecting the under-water housing or pylon with the upper part of the outboard drive. The energy supply or battery is preferably integrated into the outboard drive. The inventive boat drive including the battery has an overall weight of less than 15 kg, more preferred less than 10 kg. Thus, the outboard drive is easy to handle.

For power transmission and cooling, it is preferable to place the motor into the pylon of an outboard boat drive. The pylon should have a small radial extension. On the other hand, the torque achieved by an electric motor is proportional to the radial distance of the air gap between the stator poles and the rotor poles from the rotation axis. Thus, a motor configuration with greater radial extension normally delivers a larger torque. The inventive construction as an external rotor motor is a solution between these contrary requirements of a small pylon but a motor with a high torque.

The output power of the external rotor motor can be varied by changing its length in an axial direction. The output power of the motor approximately increases with its length. Normally, the pylon can normally be construed as long as desired thus not limiting the output power of the motor placed into the pylon.

As already mentioned, the inventive electric motor can turn large diameter propellers. Preferably, propellers are used which have a diameter of more than 20 cm, preferably more than 30 cm.

The present invention has several advantages compared to conventional electric boat drives. The inventive motor can, for example, be built very compact and space-saving. Further, the motor has a high power to weight ratio, i.e. the power per unit of weight is high. Especially when using a large number of poles, 10 or more, the motor delivers a high torque. The combination of a high power-weight ratio with a high torque-weight ratio makes it possible to build powerful and efficient, but lightweight and space-saving boat drives.

The motor delivers a high torque at low revolutions due to the electrical reduction. In some cases, the motor can be provided without any additional mechanical gearing.

As an example, an inventive boat drive comprises a synchronous motor with 2000 W input power which is supplied by a 24 V battery. The motor runs at 6000 rpm. An additional 1:7 mechanical gearing further reduces the number of revolutions. The diameter of the propeller is 30 cm. Such a boat drive achieves an overall efficiency of about 50%. That is, 50% of the input power supplied by the battery is converted into boat propulsion or kinetic energy (force times speed). This exemplary boat drive has a weight of 15 kg.

Boats can be divided into displacers, semi-gliders and gliders. The boat drive of the present invention is preferably adapted to propel displacers, especially displacers having a limiting velocity between 8 and 14 km/h due to this boat drive's high power-weight ratio and high torque-weight ratio.

The invention is especially useful for propelling sail boats, electric motor boats, fishing boats, rowboats, or dinghies. Boats having a length between 6 m and 14 m and a displacement up to 2 tons are preferably moved by the boat drive of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a boat drive according to the present invention;

FIG. 2 is a schematic cross section view of the inventive synchronous motor;

FIG. 3 is a schematic view of a prior art disk armature motor;

FIG. 4 is a schematic view of an external rotor motor according to the present invention; and

FIG. 5 is a schematic view of a second embodiment of the inventive motor with more power but the same torque as the motor according to FIG. 4.

### DETAILED DESCRIPTION OF THE DRAWINGS

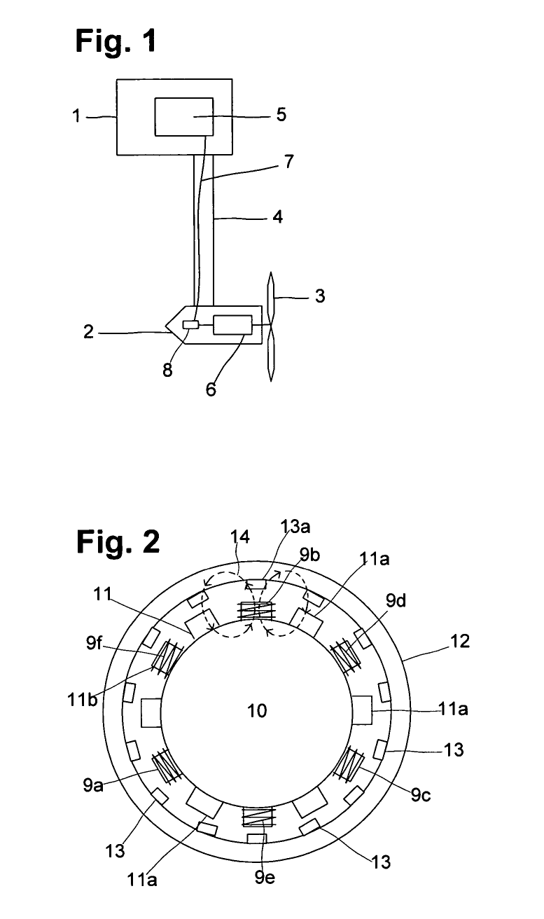

FIG. 1 shows an outboard motor which essentially comprises an upper part 1, an under-water housing or pylon 2 having a propeller 3 and a shaft 4 which connects the upper part 1 with the pylon 2. The propeller 3 has a diameter of 30 cm in this exemplary embodiment. The upper part 1 contains a battery pack 5 as a power supply. An electric motor 6, in the form of a synchronous motor, is located within the pylon 2 and propels the propeller 3 via a motor shaft. The electric motor 6 is connected to the battery pack 5 by an electrically conducting cable 7 which is located inside the shaft 4. In order to handle the high currents generated during operation of the motor 6, a cable 7 with a cross sectional area of 10 mm² is used.

FIG. 2 shows a cross sectional view of the electric motor 6. Electric motor 6 is a synchronous motor which is controlled by an electronic circuit 8, namely a so-called frequency converter for electronically converting the DC current supplied by the battery pack 5 to a three-phase alternating current.

Stator 10 of the synchronous motor 6 comprises twelve stator cores 11a, 11b wherein six stator cores 11b are provided with windings 9a, 9b, 9c, 9d, 9e, 9f. The three-phase alternating current is passed through the windings 9a, 9b, 9c, 9d, 9e, 9f of the stator 10, thus causing a rotating magnetic field in the stator 10.

Rotor 12 is bell-shaped and rotatable arranged on the outside of stator 10. That is, the motor 6 is an external, or outer, rotor motor. Along the inner circumference of rotor 12, fourteen permanent magnets are equally distributed. During operation, the rotating magnetic field of the stator 10 causes rotation of the rotor 12 to rotate.

Winding 9b is used as an example to describe, in a simplified manner, how the streamlines of the magnetic field run in the synchronous motor 6. The magnetic flux 14 which is generated in winding 9b runs along the adjacent permanent magnet 13a to the rotor 12 and then back along the neighboring stator core 11a without a winding. Thereby, the stator cores 11a without windings are also covered by the magnetic flux 14 and thus also function as magnetic poles.

In FIG. 2, the stator 10 comprises twelve magnetic poles, i.e., six pole pairs. Fourteen permanent magnets 13 are mounted to the rotor 12 resulting in seven rotor pole pairs. The number of rotor pole pairs exceeds the number of stator pole pairs by one. When a three-phase current is applied to the stator windings 9a, 9b, 9c, 9d, 9e, 9f, then the rotor 12 is caused to rotate. The rotor 12 does not rotate with the same rotational speed as the rotating magnetic field in the stator 10, but rotates 7 times slower than the rotating magnetic field. Thus, synchronous motor 6 shows a reduction of 1:7.

At any position of rotor 12, there is always more than one of the permanent magnets 13 in close proximity to the magnetic stator poles 11a, 11b. The mutual overlap of the magnetic poles 13, 11a, 11b of the rotor 12 and the stator 10 is always such that at any angular position of the rotor 12 a high attractive force interacts between the magnetic poles 13 of the rotor 12 and the magnetic poles 11a, 11b of the stator 10. Consequently, the motor 6 has a high torque.

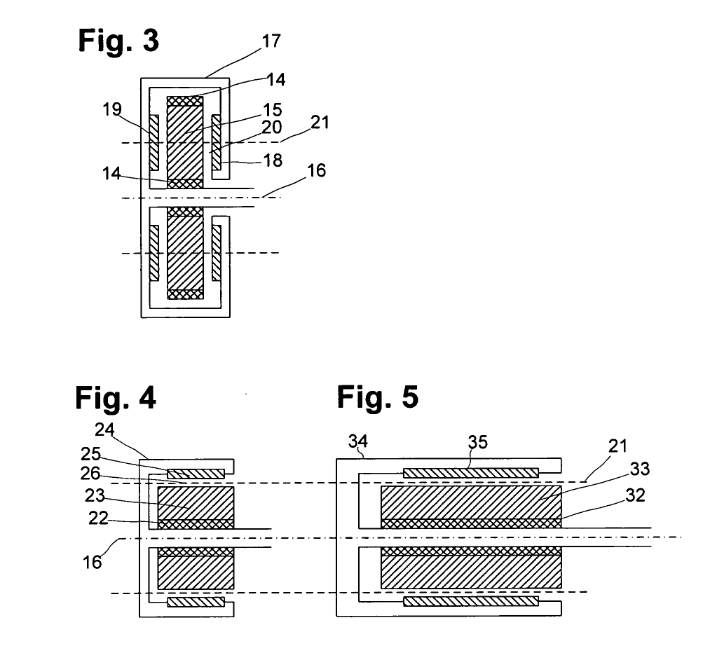

FIGS. 3 to 5 aid in explaining why the inventive motor is especially adapted to be placed in the pylon 2 of an outboard motor.

FIG. 3 shows a disk armature motor as it is for example disclosed in aforementioned U.S. Pat. No. 6,664,692 B1. The disk-shaped stator 14 carries several stator windings 15 distributed around its circumference. The axis of the stator windings 15 is parallel to the motor shaft 16 of the disk armature motor. A rotor 17 is mounted to the motor shaft 16. Two circular arrangements of permanent magnets 18, 19 are mounted to the rotor 17. At a specific position of the rotor 17, two of the permanent magnets 18, 19 are exactly positioned in front of respectively behind one of the stator windings 15. The magnetic field between the stator windings 15 and the permanent magnets 18, 19 is orientated essentially axially and parallel to the motor shaft 16.

The torque generated by the motor is approximately proportional to the mean distance of the airgap 20 between the stator windings 15 and the permanent magnets 18, 19 from the rotational axis or motor shaft 16. In FIG. 3, the position of that mean distance is shown as a dashed line.

For comparison, FIG. 4 shows the motor configuration according to the invention. The motor is an external rotor motor. The stator 22 carries stator windings 23 which are concentrically arranged on the circumference of the stator 22. However, the symmetry axis of each stator winding 23 is directed radially. The rotor 24 is shaped like a bell and surrounds the stator windings 23. Permanent magnets are bonded on the inner surface of the rotor bell 24. In this case, the system is radially magnetizing, i.e. the magnetic field is a radial field which is perpendicular to the motor shaft 16.

The generated torque is again proportional to the radial distance of the airgap 26 from the rotational axis 16. It can be easily seen that the airgap 26 between the stator windings 23 and the rotor magnets 25 is located in the outer part of the motor. Thus, a high torque and a compact design can be achieved.

Finally, FIG. 5 shows an inventive motor which has the same torque but a higher power compared to the motor shown in FIG. 4. Stator 32, stator windings 33, rotor 34 and the permanent magnets 35 essentially differ from the arrangement according to FIG. 4 only in that they are more extended in the axially direction. Thereby, a higher motor power is achieved. The radial extension of the motors according to FIGS. 4 and 5 is the same so that both motors provide more or less the same torque.

What is claimed is:

1. Boat drive, comprising a permanent magnet-excited, electronically commutated, synchronous motor having a stator and a rotor, wherein the number of poles of said stator and the number of poles of said rotor are different, the magnetic field created between said poles of said stator and said poles of said rotor is an essentially radial field with respect to a shaft of said rotor, and said poles of said rotor have a distance from said shaft of said rotor greater than said poles of said stator.

2. Boat drive according to claim 1, wherein said stator comprises stator cores, wherein half of said stator cores are provided with a stator winding.

3. Boat drive according to claim 1, wherein the number of pair of poles of said stator and the number of pair of poles of said rotor differ from each other by ±1.

4. Boat drive according to claim 3, wherein said stator comprises stator cores, wherein half of said stator cores are provided with a stator winding.

5. Boat drive according to claim 1, wherein the rotor comprises 4 to 8 pairs of poles.

6. Boat drive according to claim 1, wherein the rotor comprises 5 to 7 pairs of poles.

7. Boat drive according to claim 1, wherein a sensorless controller is operatively associated with said motor.

8. Boat drive according to claim 1, wherein a propeller having a diameter of more than 20 cm is operatively associated with said motor.

9. Boat drive according to claim 8, wherein the diameter is at least 30 cm.

10. Boat drive according to claim 1, wherein said motor has a power between 100 W and 10 kW.

11. Boat drive according to claim 10, wherein the power is between 500 W and 5000 W.

12. Boat drive according to claim 1, wherein said motor is housed in a pylon.

13. Use of a boat drive according to claim 1, comprising propelling a displacer boat with said boat drive.
